(19) United States
(12) Patent Application Publication
(10) Pub. No.: US 2025/0305343 A1
(43) Pub. Date: Oct. 2, 2025

(54) LID OPENING AND CLOSING DEVICE

(71) Applicant: U-Shin Ltd., Nagano (JP)

(72) Inventor: Yohei ISOGAI, Hiroshima (JP)

(21) Appl. No.: 19/073,449

(22) Filed: Mar. 7, 2025

(30) Foreign Application Priority Data
Mar. 28, 2024 (JP) 2024-054136

(51) Int. Cl. E05F 15/63; B60K 15/05; E05B 81/90; E05B 83/34

(52) U.S. Cl. CPC E05F 15/63; B60K 15/05; E05B 81/90; E05B 83/34; B60K 2015/053; B60K 2015/0576; E05Y 2201/676; E05Y 2900/534

(57) ABSTRACT

A groove serving as a manipulation receiving portion of a spindle lever of a lid opening and closing device has a side wall serving as a lock operating part that is brought into contact with a manipulation portion of a drive lever and inhibits the drive lever from rotating in an opening drive direction when the spindle lever is biased in an opening operating direction by external force acting on a lid at a fully closed position to move the lid to a fully open position.

### CROSS REFERENCE TO RELATED APPLICATION

This application claims benefit of priority to Japanese Patent Application No.2024-054136, filed Mar. 28, 2024, the entire content of which is incorporated herein by reference.

### BACKGROUND

### Technical Field

The present disclosure relates to a lid opening and closing device.

### Background Art

A lid opening and closing device disclosed in JP 2014-210473 A includes a lid that covers and uncovers an opening portion of a receiving port for receiving energy which is provided in a vehicle, and an opening and closing device that opens and closes the lid. The opening and closing device includes a link mechanism that connects a vehicle body and the lid to each other, and an electric motor that drives the link mechanism. The link mechanism is operated by a driving force of the electric motor, thereby causing the lid to move between a fully closed position where the opening portion is covered and a fully open position where the opening portion is uncovered. That is, the lid is automatically opened and closed.

### SUMMARY

The lid opening and closing device of Patent Document 1 does not include a lock mechanism that inhibits operation of the lid at the fully closed position. A lock mechanism may be added, thereby enabling the safety of the lid opening and closing device to be enhanced. For example, a lock member for locking the lid at the fully closed position and a drive mechanism that drives the lock member may be provided, thereby enabling the operation of the lid at the closed position to be inhibited. However, in this case, it is necessary to provide a drive mechanism for the lock member separately from the motor for opening and closing the lid. Hence, this results in an increase in the number of components of the lid opening and closing device and intricacy due to the increase in the number of components.

An object of the present disclosure is to provide a lid opening and closing device capable of locking a lid while increase in the number of components and intricacy are curbed.

An aspect of the present disclosure provides a lid opening and closing device including: an electric motor; a drive lever that has a manipulation portion and is rotated around a drive shaft by a driving force of the electric motor; a lid configured to be movable between a fully closed position where an opening portion of a vehicle body is covered and a fully open position where the opening is uncovered; and a spindle lever that is rotatable around a spindle shaft, has a manipulation receiving portion which is brought into contact with the manipulation portion, and is rotated around the spindle shaft by a manipulation force from the manipulation portion which is received by the manipulation receiving portion such that the lid is interlocked with the spindle lever to move between the fully closed position and the fully open position. The drive shaft has an axis extending in the same direction as an axis of the spindle shaft. The drive shaft and the spindle shaft are disposed at positions eccentric to each other when viewed from a direction in which the axis extends. The manipulation receiving portion includes an opening operating part that is brought into contact with the manipulation portion when the drive lever is rotated in an opening drive direction by the driving force of the electric motor and that rotates the spindle lever in an opening operating direction which is a direction in which the lid is interlocked with the spindle lever to move toward the fully open position, a closing operating part that is brought into contact with the manipulation portion when the drive lever is rotated in a closing drive direction which is an opposite direction to the opening drive direction by the driving force of the electric motor and that rotates the spindle lever in a closing operating direction which is a direction in which the lid is interlocked with the spindle lever to move toward the fully closed position, and a lock operating part that is brought into contact with the manipulation portion and inhibits the drive lever from rotating in the opening drive direction when the spindle lever is biased in the opening operating direction by external force acting on the lid at the fully closed position to move the lid to the fully open position.

Movement of the lid between the fully open position and the fully closed position by the driving force of the electric motor is realized by causing the manipulation portion of the drive lever to come into contact with the opening operating part or the closing operating part of the manipulation receiving portion of the spindle lever. When an external force acts on the lid at the fully closed position to move the lid to an open position, the spindle lever is biased in the opening operating direction, but the manipulation portion of the drive lever is in contact with the lock operating part of the manipulation receiving portion provided on the spindle lever, and the rotation of the drive lever in the opening drive direction is inhibited. As a result, the spindle lever does not rotate in the opening operating direction, and the lid is maintained at the fully closed position, that is, maintained in a locked state. As described above, the locking of the lid at the fully closed position is realized by the two members of the drive lever and the spindle lever, and there is no need to provide a lock lever for locking the lid and a drive unit for driving the lock lever. Hence, according to the lid opening and closing device of the present disclosure, the locking of the lid can be realized while increase in the number of components and intricacy are curbed, and increase in manufacturing costs of the lid opening and closing device can be curbed.

According to the lid opening and closing device of the present disclosure, the lid can be locked while increase in the number of components, intricacy, and increase in costs due to the increase are curbed.

### BRIEF DESCRIPTION OF DRAWINGS

FIG. 1 is a perspective view of a lid opening and closing device from a vehicle exterior side according to an embodiment of the present disclosure (fully open position);

FIG. 2 is a perspective view of the lid opening and closing device from a vehicle interior side according to the embodiment of the present disclosure (fully open position);

FIG. 3 is a perspective view of the lid opening and closing device from the vehicle exterior side according to the embodiment of the present disclosure (fully closed position);

FIG. 4 is an exploded perspective view of the lid opening and closing device from the vehicle exterior side according to the embodiment of the present disclosure;

FIG. 5 is an exploded perspective view of the lid opening and closing device from the vehicle interior side according to the embodiment of the present disclosure;

FIG. 6 is a perspective view of a link mechanism, a spindle lever, a drive lever, and an emergency lever;

FIG. 7 is a perspective view of the link mechanism, the spindle lever, and the drive lever;

FIG. 8 is an exploded perspective view of FIG. 7;

FIG. 9 is an exploded perspective view of FIG. 7;

FIG. 10 is a schematic view of the drive lever and the spindle lever;

FIG. 11 is a schematic view for illustrating opening and closing operations of the lid;

FIG. 12 is a schematic view of a lid opening and closing device according to a modification example of the present disclosure (fully open position);

FIG. 13 is a schematic view of the lid opening and closing device according to the modification example of the present disclosure (half-opened position); and

FIG. 14 is a schematic view of the lid opening and closing device according to the modification example of the present disclosure (fully closed position).

### DETAILED DESCRIPTION

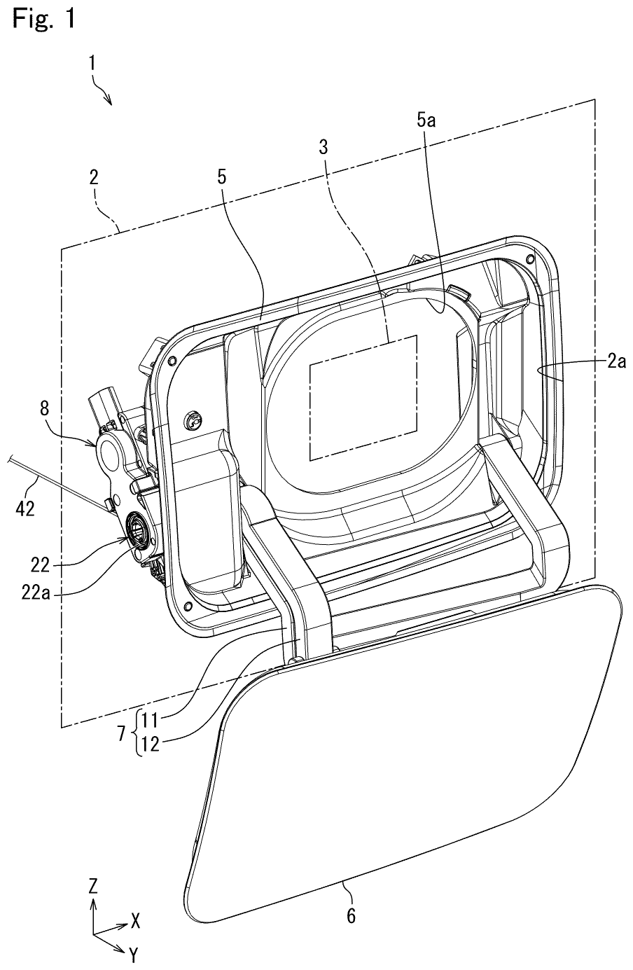

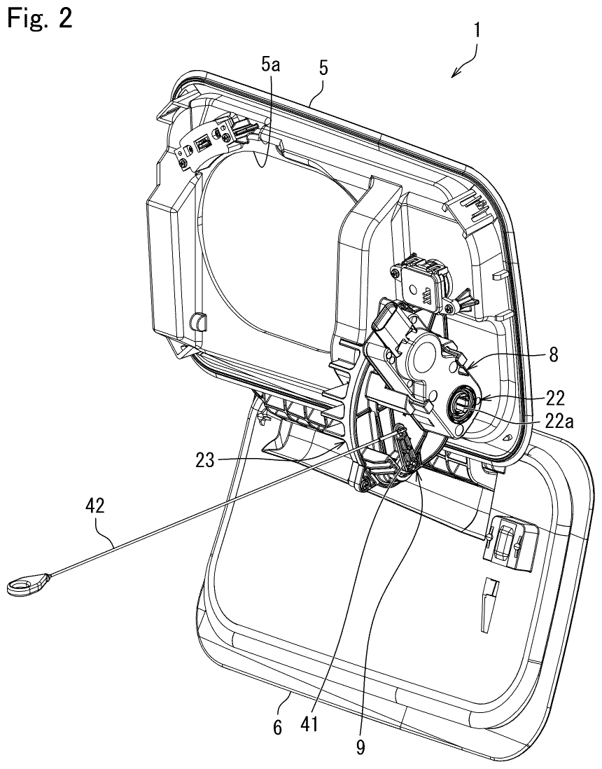

With reference to FIGS. 1 and 2, a lid opening and closing device 1 according to an embodiment of the present disclosure is attached to a through-hole 2a (an opening portion) of a side panel 2 constituting a vehicle body of a motor vehicle which is an example of a vehicle. On a vehicle interior side of the side panel 2, a power supply connector 3, which is an example of a reception portion, is provided to face the through-hole 2a. The reception portion may be a reception port for a liquid fuel such as gasoline or light oil, a liquid fuel such as liquid hydrogen or LP gas, a gaseous fuel, or a solid fuel.

In the drawings, an X direction, a Y direction, and a Z direction are a vehicle length direction, a vehicle width direction, and a vehicle height direction of a motor vehicle, respectively.

The lid opening and closing device 1 includes a frame 5, a lid 6, a link mechanism 7, a drive mechanism 8, and an emergency mechanism 9.

The frame 5 has a shallow vessel shape with an opening on a vehicle exterior side, and is attached to the side panel 2 from the vehicle interior side to cover the through-hole 2a. The frame 5 has a window hole 5a provided at the center thereof to face the power supply connector 3 in the vehicle width direction.

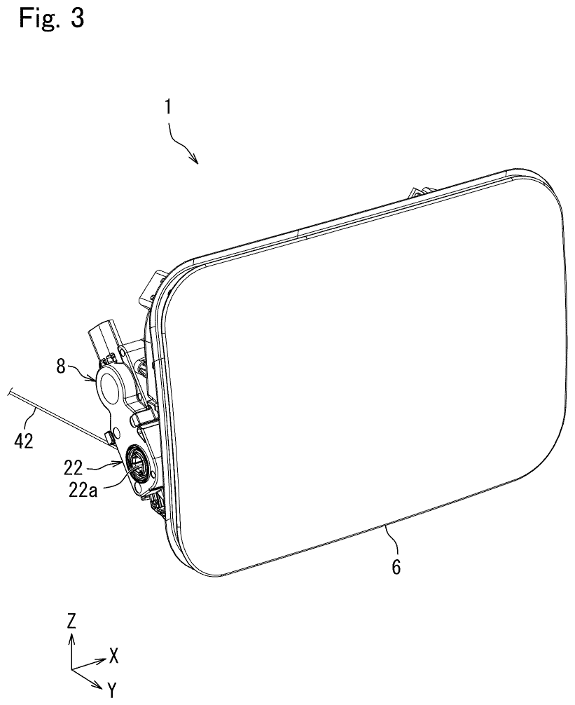

The lid 6 is configured to be vertically movable, when viewed in the vehicle width direction, between a position where the opening of the frame 5 illustrated in FIG. 3 is fully covered, that is, a fully closed position where the through-hole 2a is covered, and a position where the opening of the frame 5 illustrated in FIGS. 1 and 2 is fully uncovered, that is, a fully open position where the through-hole 2a is fully uncovered to enable access to the power supply connector 3.

The link mechanism 7 connects the lid 6 and the frame 5 to each other such that the lid 6 is movable between the fully closed position and the fully open position. As will be described below, the link mechanism 7 is operated by a rotational driving force transmitted from the drive mechanism 8, thereby moving the lid 6 between the fully closed position and the fully open position.

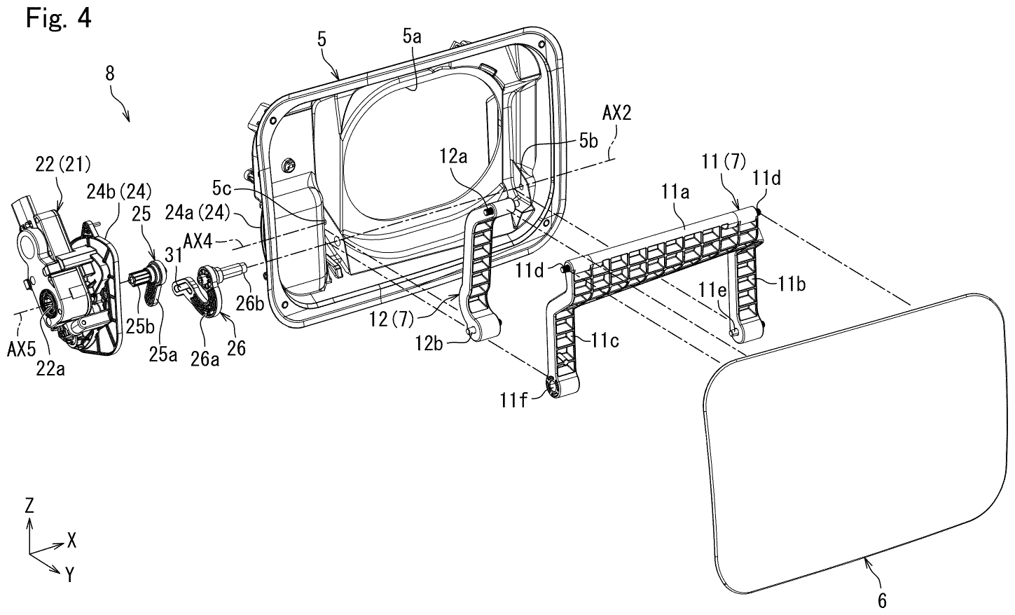

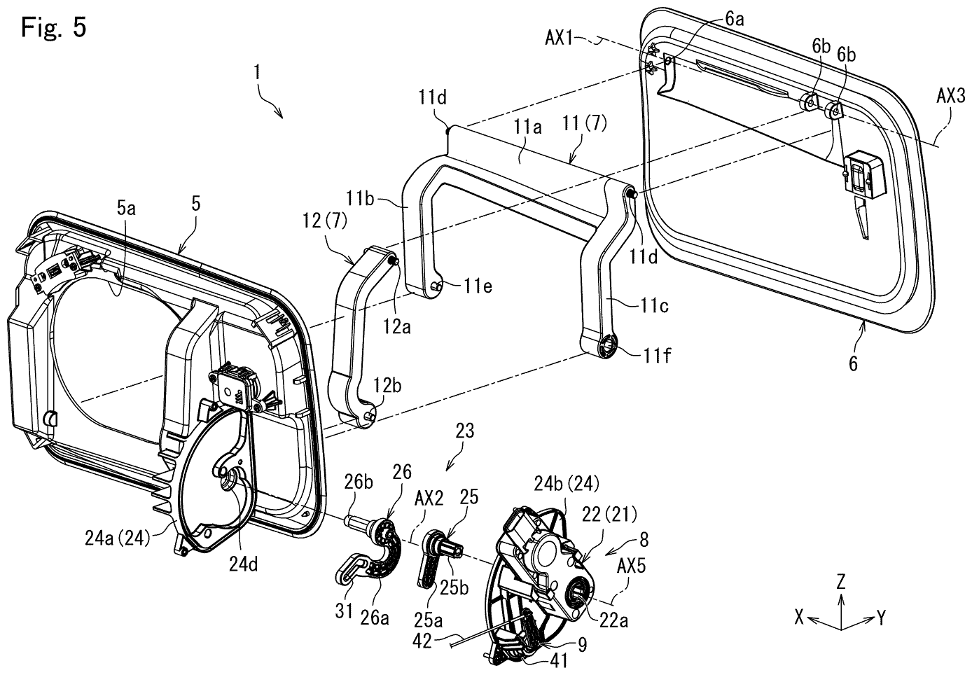

With reference to FIGS. 4 and 5, the link mechanism 7 includes a first link member 11 and a second link member 12.

The first link member 11 includes a connection portion 11a extending in the vehicle length direction, a first arm portion 11b extending from one end of the connection portion 11a, and a second arm portion 11c extending from the other end of the connection portion 11a.

Both ends of the connection portion 11a are connected to the lid 6 to be rotatable around a horizontal axis AX1 extending in the vehicle length direction. Specifically, pins 11d projecting from both ends of the connection portion 11a are inserted into bearing holes 6a (illustrated only in FIG. 5) provided in the lid 6. A distal end of the first arm portion 11b is connected to the frame 5 to be rotatable around a horizontal axis AX2 extending in the vehicle length direction at a position spaced downward from the axis AX1. Specifically, a pin 11e projecting from the distal end of the first arm portion 11b is inserted into a bearing hole 5b (illustrated only in FIG. 4) provided in the frame 5. As will be described below, a distal end of the second arm portion 11c is rotatable, together with the spindle lever 26 of the link mechanism 7, around the spindle shaft 26b around the axis AX2, with respect to the frame 5.

The second link member 12 is disposed adjacent to the second arm portion 11c of the first link member 11. One end (an upper end in FIGS. 4 and 5) of the second link member 12 is connected to the lid 6 to be rotatable around a horizontal axis AX3 extending in the vehicle length direction at a position spaced upward from the axis AX1. Specifically, a pin 12a projecting from one end of the second link member 12 is inserted into a bearing hole 6b (illustrated only in FIG. 5) provided in the lid 6. The other end (a lower end in FIGS. 4 and 5) of the second link member 12 is connected to the frame 5 to be rotatable around a horizontal axis AX4 extending in the vehicle length direction at a position spaced upward from the axis A2. Specifically, a pin 12b projecting from the other end of the second link member 12 is inserted into a bearing hole 5c provided in the frame 5.

As described above, the lid 6 is connected to the frame 5 via the link mechanism 7 to have the four rotation axes AX1 to AX4. The frame 5, the first link member 11, the second link member 12, and the lid 6 form a kind of four-node rotation chain.

With reference to FIGS. 4 and 5, the drive mechanism 8 includes an actuator 22 that includes an electric motor 21 and outputs the rotational driving force of the electric motor 21 from an output portion 22a. The rotational driving force output from the output portion 22a of the actuator 22 indicates forward and reverse rotation around a horizontal axis AX5 extending in the vehicle length direction at a position spaced upward from the axis AX2. The drive mechanism 8 further includes a transmission mechanism 23 that is interposed between the actuator 22 and the link mechanism 7, operates the link mechanism 7 in response to the rotational driving force of the electric motor 21, and realizes the movement of the lid 6 between the fully closed position and the fully open position.

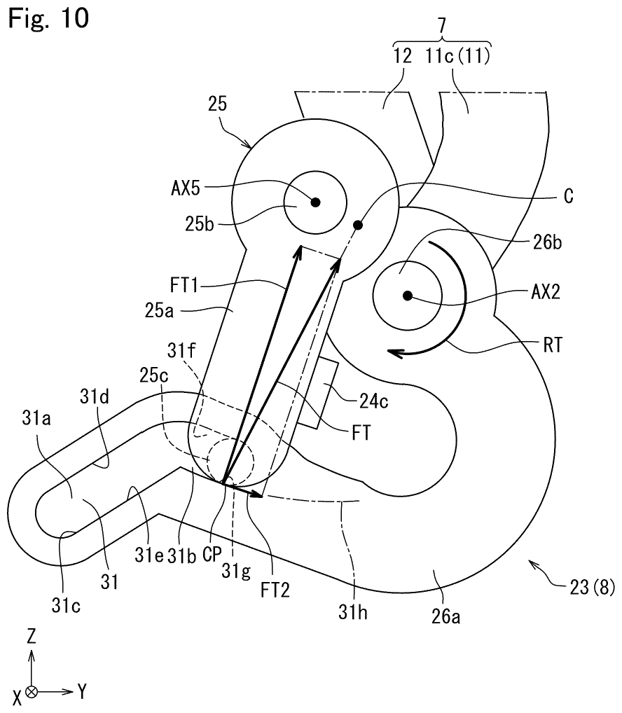

As illustrated most clearly in FIG. 5, the transmission mechanism 23 includes a casing 24 fixed to the frame 5 on the vehicle interior side. The casing 24 includes a shallow vessel-shaped main body 24a open on lateral sides thereof, and a cover 24b that covers an opening of the main body 24a. The main body 24a has a stopper 24c (illustrated only in FIG. 10).

An overview of the transmission mechanism 23 will be described with reference to FIGS. 4 to 6.

The transmission mechanism 23 includes a drive lever 25 and the spindle lever 26. The drive lever 25 is connected to the actuator 22 so that the rotational driving force is transmitted. The spindle lever 26 is connected to the distal end of the second arm portion 11c of the first link member 11 constituting the link mechanism 7 so as not to be relatively rotatable, and the spindle lever 26 is rotatable together with the first link member 11 around the axis AX2 described above. The spindle lever 26 and the first link member 11 may be integrated as a single member. When the drive lever 25 is rotated by the rotational driving force of the electric motor 21 output from the output portion 22a of the actuator 22, the rotation is transmitted to the spindle lever 26 by engagement of a manipulation portion 25c with a groove 31 to be described below, and the spindle lever 26 is rotated. As a result, the first link member 11 is rotated together with the spindle lever 26, so that the link mechanism 7 is operated. In the transmission mechanism 23, the drive lever 25 is a driving lever, and the spindle lever 26 constitutes a kind of counter cam or reverse cam which becomes a driven lever.

Hereinafter, the transmission mechanism 23 will be described in more detail.

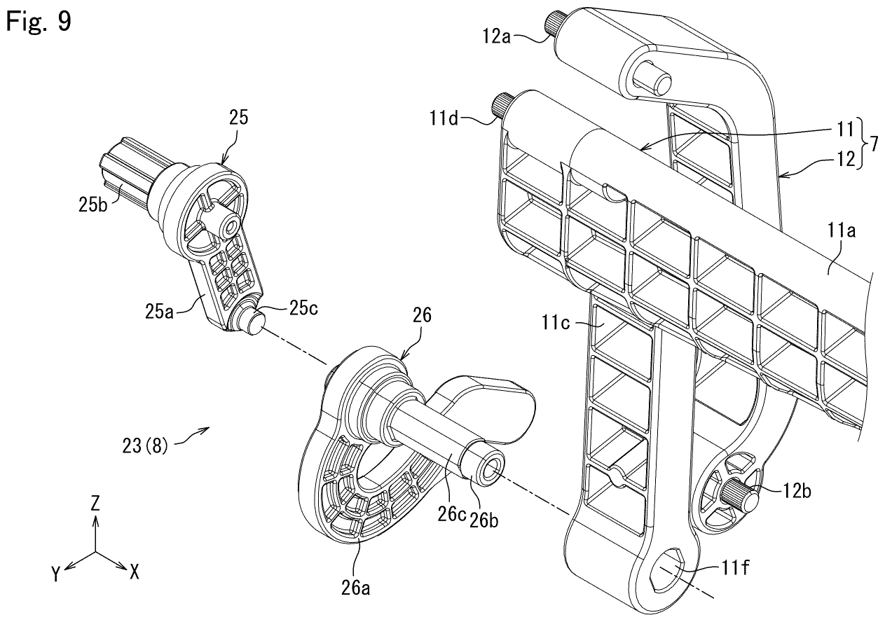

With reference to FIGS. 4 to 6, the drive lever 25 includes an arm 25a accommodated inside the casing 24 (a closed space defined by the main body 24a and the cover 24b), and a drive shaft 25b projecting in the vehicle length direction from one end of the arm 25a. The drive shaft 25b penetrates the cover 24b of the casing 24 and is fitted into the output portion 22a of the actuator 22. Hence, the drive lever 25 is rotated around the drive shaft 25b around the axis AX5 by the driving force of the electric motor 21 provided in the actuator 22. With reference to FIG. 9 as well, at the other end of the arm 25a, a short column-shaped or pin-shaped manipulation portion 25c is provided to project in the vehicle length direction.

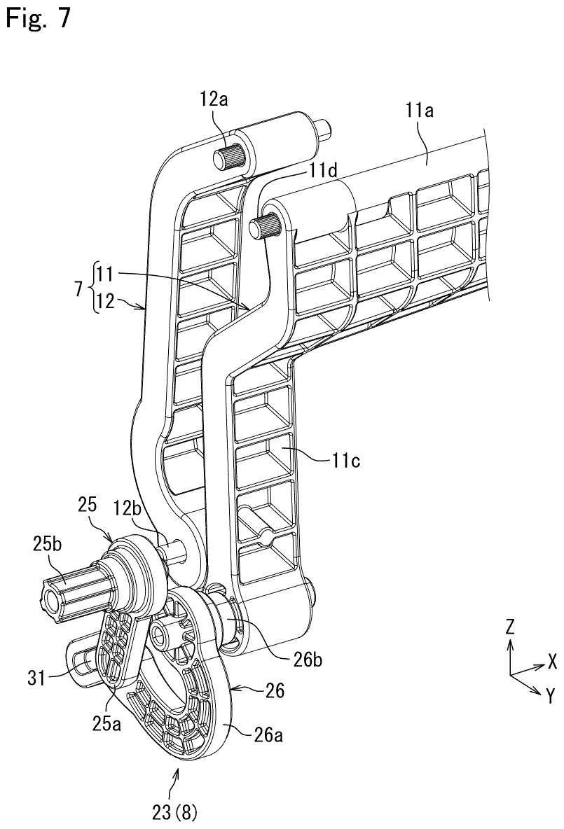

With continued reference to FIGS. 4 to 6, the spindle lever 26 includes an arm 26a accommodated in the casing 24 and a spindle shaft 26b projecting in the vehicle length direction from one end of the arm 26a. The arm 26a is disposed at a bottom portion of the main body 24a of the casing 24, and the arm 25a of the drive lever 25 is disposed to overlap the arm 26a. The spindle shaft 26b is inserted into a through-hole 24d provided in a bottom wall of the main body 24a and projects to the outside of the casing 24. With reference to FIGS. 7 to 9 as well, an insertion portion 26c having a non-circular cross section is provided in a portion of the spindle shaft 26b which projects from the casing 24. Meanwhile, in the second arm portion 11c of the first link member 11, a non-circular connection hole 11f is provided at an end portion of the second arm portion opposite to the connection portion 11a. When the insertion portion 26c is inserted into the connection hole 11f, the spindle lever 26 and the first link member 11 are connected so as not to be relatively rotatable. When the spindle lever 26 is rotated around the axis AX2, the first link member 11 is also rotated around the axis AX2.

The axis AX5 of the rotation of the drive shaft 25b of the drive lever 25 and the axis AX2 of the rotation of the spindle shaft 26b of the spindle lever 26 both extend horizontally in the vehicle length direction as described above. That is, the axis AX5 of the rotation of the drive shaft 25b of the drive lever 25 and the axis AX2 of the rotation of the spindle shaft 26b of the spindle lever 26 extend in the same direction. Also, with reference to FIG. 10, the axis AX5 of the rotation of the drive shaft 25b of the drive lever 25 and the axis AX2 of the rotation of the spindle shaft 26b of the spindle lever 26 are arranged at positions eccentric to each other when viewed in the direction in which the axes AX2 and AX5 extend.

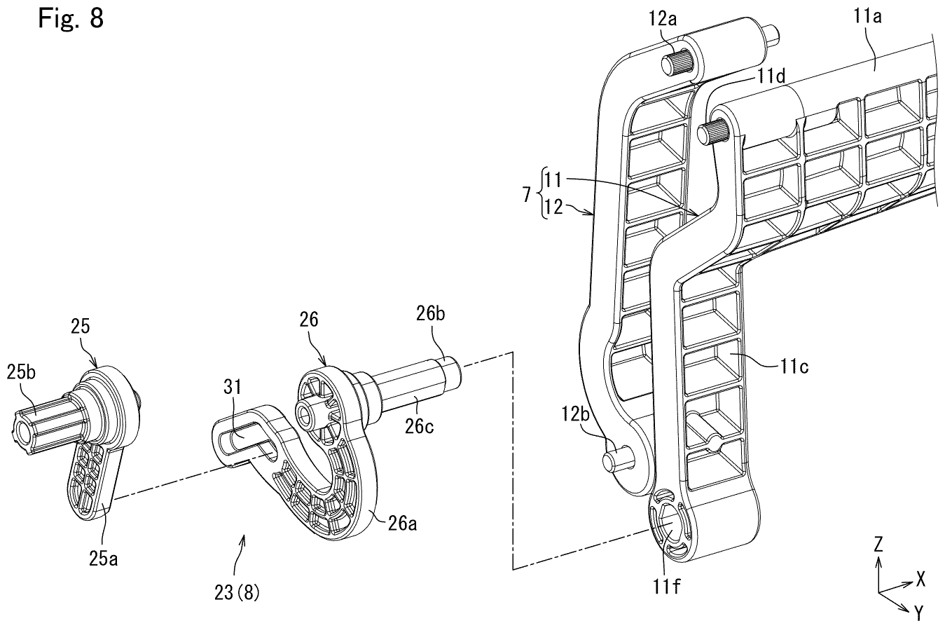

With reference to FIG. 8, the arm 26a of the spindle lever 26 has the groove 31 on a side opposite to the spindle shaft 26b so that the groove 31 faces the arm 25a of the drive lever 25. In the present embodiment, the groove 31 is a bottomed groove, but may penetrate the arm 26a in a thickness direction thereof. The manipulation portion 25c (see FIG. 9 as well) is inserted into the groove 31.

Hereinafter, the groove 31 will be described.

With reference to FIG. 10, the groove 31 has a linear portion (operation groove portion) 31a extending in a direction away from the drive shaft 25b and an arcuate portion (lock groove portion) 31b provided to communicate with the linear portion 31a. The manipulation portion 25c is brought into contact with a groove side wall (manipulation receiving portion) 31c of the groove 31.

When the manipulation portion 25c is brought into contact with, of the groove side wall 31c, a pair of groove side walls 31d and 31e of a part of the linear portion 31, the groove side walls 31d and 31e facing each other, the spindle lever 26 is rotated centered on the spindle shaft 26b around the axis AX2 in a direction corresponding to the direction of the rotation of the drive lever 25 centered on the drive shaft 25b around the axis AX5. Depending on the direction of the rotation of the spindle lever 26, the link mechanism 7 is operated, and the lid 6 is moved toward the fully open position or the fully closed position.

When the manipulation portion 25c is brought into contact with, of the side walls 31d and 31e of the linear portion 31, the side wall 31d (an opening operating part) positioned on the inner side in FIG. 10, that is, on a side close to the drive shaft 25b (the axis AX5) and the spindle shaft 26b (the axis AX2), the lid 6 is moved toward the fully open position by the rotation of the spindle 26 and operation of the link mechanism 7 driven by the rotation of the spindle.

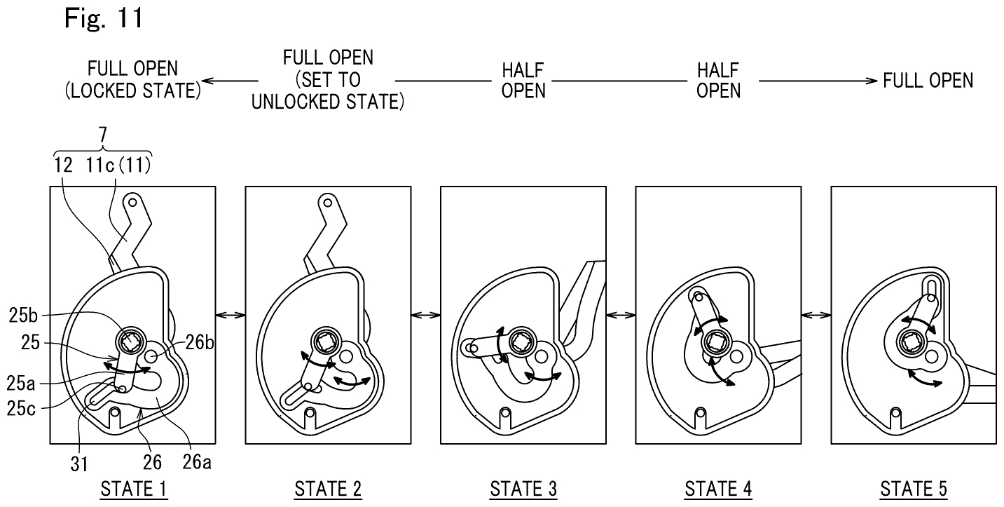

For example, a state in which the lid 6 is located at the fully closed position is set as an unlocked state. That is, when the drive lever 25 is located at a rotating angle position at which the manipulation portion 25c is located at an end portion of the linear portion 31 on the arcuate portion 31b side (State 2 in FIG. 11), and the drive lever 25 is rotated in the clockwise direction (an opening drive direction) in FIGS. 10 and 11, the manipulation portion 25c is brought into contact with and presses the side wall 31d, so that the spindle lever 26 is also rotated in the clockwise direction (an opening operating direction) in FIGS. 10 and 11. In response to the rotation of the spindle lever 26, the first arm portion 11b of the link mechanism 7 is rotated in the clockwise direction in FIGS. 10 and 11 around the spindle shaft 26b, and the lid 6 is moved toward the fully open position in response to the operation of the link mechanism 7 in response to the rotation of the first arm portion (in FIG. 11, transition from State 2 to State 5 sequentially).

When the manipulation portion 25c is brought into contact with, of the side walls 31d and 31e of the linear portion 31, the side wall 31e (a closing operating part) positioned on the outer side in FIG. 10, that is, a side away from the drive shaft 25b (the axis AX5) and the spindle shaft 26b (the axis AX2), the lid 6 is moved toward the fully closed position in response to the rotation of the spindle 26 and the operation of the link mechanism 7 driven by the rotation of the spindle. The side wall 31e is linear when viewed from the direction in which the axes AX2 and AX5 extend.

For example, when the lid 6 is located at the fully open position (State 5 in FIG. 11) and the drive lever 25 is rotated in the counterclockwise direction (a closing drive direction) in FIGS. 10 and 11, the manipulation portion 25c is brought into contact with and presses the side wall 31e so that the spindle lever 26 is also rotated in the counterclockwise direction (a closing operation direction) in FIGS. 10 and 11. In response to the rotation of the spindle lever 26, the first arm portion 11b of the link mechanism 7 is rotated in the counterclockwise direction in FIGS. 10 and 11 around the spindle shaft 26b, and the lid 6 is moved toward the fully closed position in response to the operation of the link mechanism 7 in response to the rotation of the first arm (in FIG. 11, transition from State 5 to State 2 sequentially).

With reference to FIG. 10, the side wall 31g (a lock operating part) positioned on an outer side of side walls 31f and 31g of the arcuate portion 31b, that is, a side away from the drive shaft 25b (the axis AX5) and the spindle shaft 26b (the axis AX2), is brought into contact with the manipulation portion 25c, so that the lid 6 at the fully closed position enters into a locked state. The side wall 31g has an arc shape when viewed in the direction in which the axes AX2 and AX5 extend. An arc center C of the side wall 31g in the present embodiment is positioned at a position shifted from the rotation axis AX5 of the drive shaft 25b toward the rotation axis AX2 of the spindle shaft 26b.

When the lid 6 is located at the fully closed position and is in the locked state (State 1 in FIGS. 10 and 11), the rotating angle position of the drive lever 25 around the axis AX5 is set such that the manipulation portion 25c is positioned at an end portion of the arcuate portion 31b of the groove 31. In this state, when an external force (for example, generated by an action to forcibly open the lid 6 with a hand or vibration thereof) capable of moving the lid 6 to the fully open position acts on the lid 6, the external force is transmitted to the spindle lever 26 via the link mechanism 7, and rotation torque (rotation torque to bias the spindle lever 26 in the opening operating direction) represented by an arrow RT in FIG. 10 acts on the spindle lever 26. The rotation torque is transmitted to the drive lever 25 via the side wall 31g of the groove 31. That is, when an external force capable of moving the lid 6 to the fully open position acts on the lid 6, the spindle lever 26 and the drive lever 25 constitute a kind of groove cam in which the former serves as a driving lever and the latter serves as a driven lever.

Force FT transmitted from the side wall 31g (the spindle lever 26 side) to the manipulation portion 25c (the drive lever 25 side) by the rotation torque RT acting on the spindle lever 26 is force from a contact point CP between the side wall 31g and the manipulation portion 25c toward the arc center C. The force FT is decomposed into component force FT1 from the contact point CP toward the axis AX5 of the rotation of the drive shaft 25b and component force FT2 which is force in a tangential direction of an arc 31h formed by the side wall 31g at the contact point CP. The former component force FT1 does not bias the drive lever 25 to make the drive lever rotate around the drive shaft 25b, but the latter component force FT2 biases the drive lever 25 to make the drive lever rotate around the drive shaft 25b. As described above, the axis AX5 of the rotation of the drive shaft 25b and the axis AX2 of the rotation of the spindle shaft 26b are located at positions eccentric to each other, and the arc center C of the side wall 31 is located at a position shifted from the axis AX5 of the rotation of the drive shaft 25b toward the rotation axis AX2 of the spindle shaft 26b. By setting the positions of the axes AX2 and AX5 and the arc center C, the component force FT2 biases the drive lever 25 so that the drive lever is rotated in the counterclockwise direction (the closing drive direction) in FIG. 10 around the drive shaft 25b. The rotation of the drive lever 25 in response to this biasing is inhibited by being brought into contact with the stopper 24c. As described above, even if an external force capable of moving the lid 6 to the fully open position acts on the lid 6, the rotation of the drive lever 25 in the opening drive direction is inhibited, and the rotation of the drive lever 25 in the closing drive direction opposite thereto is inhibited by the stopper 24c. As a result, even if an external force capable of moving the lid 6 to the fully open position acts on the lid 6, the lid 6 is maintained at the fully closed position, that is, maintained in the locked state.

As described above, the locking of the lid 6 at the fully closed position is realized by two members of the drive lever 25 and the spindle lever 26, and there is no need to provide a lock lever for locking the lid 6 and a drive mechanism for driving the lock lever. Hence, according to the lid opening and closing device 1 of the present embodiment, the locking of the lid 6 can be realized while increase in the number of components and intricacy are curbed, and increase in manufacturing costs of the lid opening and closing device 1 can be curbed.

In FIG. 10, the arc center C of the arc 31h of the side wall 31g may coincide with the axis AX5 of the rotation of the drive lever 25 around the drive shaft 25b. In the case of this setting, when the rotation torque RT acting on the spindle lever 26 is generated by the external force capable of moving the lid 6 to the fully open position, the force FT applied from the side wall 31g to the manipulation portion 25c becomes force from the contact point CP toward the axis AX5. That is, in this case, the force FT does not have the component force T2 capable of rotating the drive lever 25. Hence, even if the arc center C of the arc 31h of the side wall 31g coincides with the axis AX5 of the rotation of the drive lever 25 around the drive shaft 25b, the lid 6 can be maintained at the fully closed position, that is, maintained in the locked state, against the external force capable of moving the lid 6 to the fully open position.

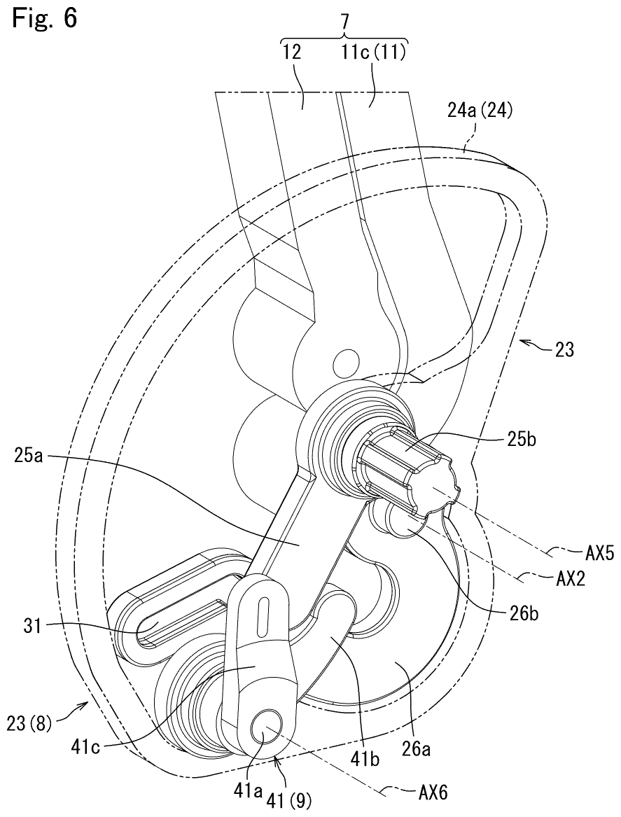

With reference to FIGS. 2 and 6, the emergency mechanism 9 includes an emergency lever 41 and a wire 42 which is a traction member capable of performing pulling manipulation from a vehicle interior of a motor vehicle. The emergency lever 41 includes a shaft 41a rotatable around an axis AX6 positioned outside the arm 26a of the spindle lever 26, and two arms 41b and 41c extending from the shaft 41a. One arm 41b is disposed adjacent to the arm 25a of the drive lever 25 on the closing drive direction side. The wire 42 is connected to the other arm 41c. For example, when an in-vehicle battery that supplies power to the electric motor 21 is in an overdischarge state, the emergency lever 41 is rotated around the axis AX6 when the wire 42 is manipulated to be pulled. In response to this rotation, the arm 41b presses the arm 25a of the drive lever 25 so that the drive lever 25 is rotated in the opening drive direction. As a result, the spindle lever 26 is rotated in the opening operating direction, and the lid 6 is moved toward the fully open position.

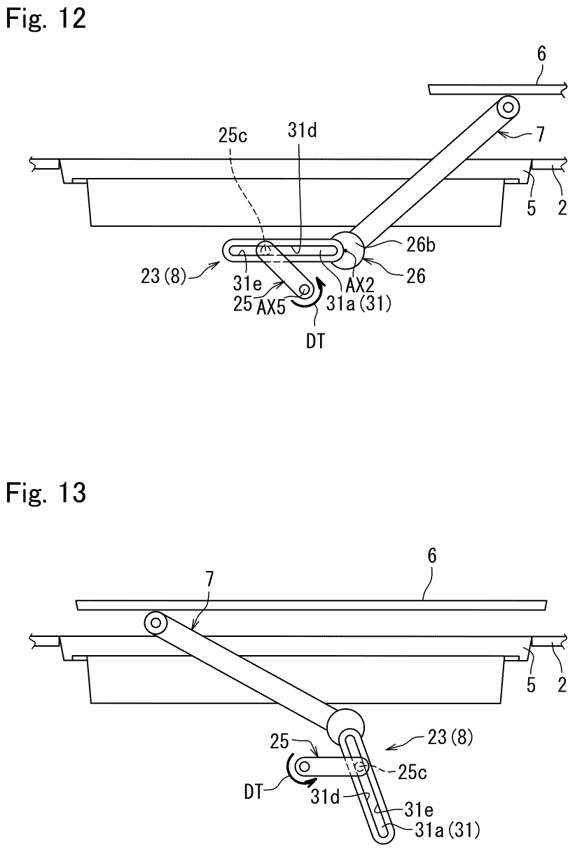

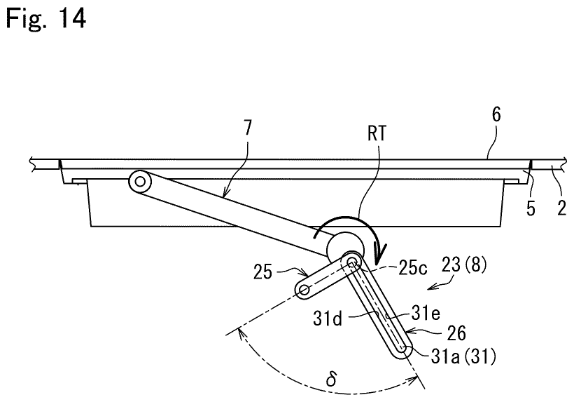

FIGS. 12 to 14 illustrate a lid opening and closing device according to a modification example. The lid 6 is located at the fully open position in FIG. 12, and is moved through a half-opened position in FIG. 13 to the fully closed position in FIG. 14. In FIGS. 12 and 13, an arrow DT represents the driving torque applied from the actuator 22 to the drive lever 25 at the time of movement to the fully closed position. In this modification example, the groove 31 includes only the linear portion 31a, an end portion of the side wall 31e on the spindle shaft 26b side serves as the lock operating part, and the other part of the side wall 31e serves as the closing operating part. When an external force capable of moving the lid 6 to the fully open position acts on the lid 6 at the fully closed position in FIG. 14, the external force is transmitted to the spindle lever 26 via the link mechanism 7, and the rotation torque RT (rotation torque for biasing the spindle lever 26 in the opening operating direction) is applied. However, in the state of FIG. 14, a pressure angle 8, that is, an angle formed between a normal direction of the side wall 31d (a cam surface) of the groove 31 and a rotation direction of the manipulation portion 25c (follower) of the drive lever 25 when the spindle lever 26 is the driving lever and the drive lever 25 is a follower cam mechanism, is 90 degrees. That is, since the force FT applied from the side wall 31e to the manipulation portion 25c is force from the contact point CP toward the axis AX5, the drive lever 25 is not rotated, and the lid 6 is maintained in the locked state.

1. A lid opening and closing device comprising:
an electric motor;
a drive lever that has a manipulation portion and is rotated around a drive shaft by a driving force of the electric motor;
a lid configured to be movable between a fully closed position where an opening portion of a vehicle body is covered and a fully open position where the opening is uncovered; and
a spindle lever that is rotatable around a spindle shaft, has a manipulation receiving portion which is brought into contact with the manipulation portion, and is rotated around the spindle shaft by a manipulation force from the manipulation portion which is received by the manipulation receiving portion such that the lid is interlocked with the spindle lever to move between the fully closed position and the fully open position, wherein
the drive shaft has an axis extending in the same direction as an axis of the spindle shaft,
the drive shaft and the spindle shaft are disposed at positions eccentric to each other when viewed from a direction in which the axis extends, and
the manipulation receiving portion includes
an opening operating part that is brought into contact with the manipulation portion when the drive lever is rotated in an opening drive direction by the driving force of the electric motor and that rotates the spindle lever in an opening operating direction which is a direction in which the lid is interlocked with the spindle lever to move toward the fully open position,
a closing operating part that is brought into contact with the manipulation portion when the drive lever is rotated in a closing drive direction which is an opposite direction to the opening drive direction by the driving force of the electric motor and that rotates the spindle lever in a closing operating direction which is a direction in which the lid is interlocked with the spindle lever to move toward the fully closed position, and
a lock operating part that is brought into contact with the manipulation portion and inhibits the drive lever from rotating in the opening drive direction when the spindle lever is biased in the opening operating direction by an external force acting on the lid at the fully closed position to move the lid to the fully open position.

2. The lid opening and closing device according to claim 1, wherein the lock operating part is configured to be brought into contact with the manipulation portion and bias the drive lever in the closing drive direction when the spindle lever is biased in the opening operating direction by the external force acting on the lid at the fully closed position to move the lid to the fully open position.

3. The lid opening and closing device according to claim 2, comprising a stopper that inhibits the drive lever from rotating in the closing drive direction when the spindle lever is biased in the opening operating direction by the external force acting on the lid at the fully closed position to move the lid to the fully open position.

4. The lid opening and closing device according to claim 1, wherein the manipulation receiving portion has a bottomed or penetration groove shape into which the manipulation portion is inserted, and has a lock groove portion having the lock operating part, and an operation groove portion which communicates with the lock groove portion, has the opening operating part and the closing operating part, and extends in a direction away from the drive shaft.

5. The lid opening and closing device according to claim 4, wherein the lock groove portion has an arc shape centered on the drive shaft or an arc shape centered on a position shifted from the drive shaft toward the spindle shaft side.

6. The lid opening and closing device according to claim 1, comprising an emergency lever that is operable from an interior of a vehicle via a traction member, and engages with the drive lever to rotate the drive lever in the opening drive direction when the traction member is pulled.

7. The lid opening and closing device according to claim 2, wherein the manipulation receiving portion has a bottomed or penetration groove shape into which the manipulation portion is inserted, and has a lock groove portion having the lock operating part, and an operation groove portion which communicates with the lock groove portion, has the opening operating part and the closing operating part, and extends in a direction away from the drive shaft.

8. The lid opening and closing device according to claim 7, wherein the lock groove portion has an arc shape centered on the drive shaft or an arc shape centered on a position shifted from the drive shaft toward the spindle shaft side.

9. The lid opening and closing device according to claim 3, wherein the manipulation receiving portion has a bottomed or penetration groove shape into which the manipulation portion is inserted, and has a lock groove portion having the lock operating part, and an operation groove portion which communicates with the lock groove portion, has the opening operating part and the closing operating part, and extends in a direction away from the drive shaft.

10. The lid opening and closing device according to claim 9, wherein the lock groove portion has an arc shape centered on the drive shaft or an arc shape centered on a position shifted from the drive shaft toward the spindle shaft side.
